(19) United States
(12) Patent Application Publication
(10) Pub. No.: US 2024/0027073 A1
(43) Pub. Date: Jan. 25, 2024

(54) METHOD FOR OPERATING A COOKING APPLIANCE, AND COOKING APPLIANCE

(71) Applicant: Miele & Cie. KG, Guetersloh (DE)

(72) Inventor: Helge NELSON, Warendorf (DE)

(21) Appl. No.: 18/265,462

(22) PCT Filed: Nov. 30, 2021
(86) PCT No.: PCT/EP2021/083579

§ 371 Date: Jun. 6, 2023

(30) Foreign Application Priority Data
Dec. 7, 2020 (BE) 2020/5881

(51) Int. Cl. F24C 7/08; F24C 15/32; A23L 5/10; G06T 7/90

(52) U.S. Cl. CPC F24C 7/087; F24C 15/325; A23L 5/15; A23L 5/17; G06T 7/90; G06T 2207/10024

(57) ABSTRACT

A method for operating a cooking appliance having a cooking chamber for receiving a food to be cooked, a heating device for heating the cooking chamber, a circulating device including at least one fan for circulating air in the cooking chamber, and a control device for controlling at least the circulating device, the method including: recording at least one image of the food to be cooked by an image recording device; evaluating the at least one image to determine at least one surface state of the food to be cooked; determining a spatial browning profile by comparing surface states of the food to be cooked at at least two mutually spaced positions of the food to be cooked; and controlling the circulating device as a function of the spatial browning profile.

### CROSS-REFERENCE TO PRIOR APPLICATIONS

This application is a U.S. National Phase application under 35 U.S.C. § 371 of International Application No. PCT/EP2021/083579, filed on Nov. 30, 2021, and claims benefit to Belgian Patent Application No. BE 2020/5881, filed on Dec. 7, 2020. The International Application was published in German on Jun. 16, 2022 as WO/2022/122477 under PCT Article 21(2).

### FIELD

The present invention relates to a method for operating a cooking appliance, and to a corresponding cooking appliance comprising a cooking chamber for receiving a food to be cooked, a heating device for heating the cooking chamber, a circulating device comprising at least one fan for circulating air in the cooking chamber, and a control device for controlling at least the circulating device.

### BACKGROUND

When cooking food using forced convection, in the course of which air heated in the cooking chamber is circulated by means of a circulating device, the food is occasionally heated unevenly, which can adversely affect the cooking result. This is generally due to unfavorable air flow conditions in the cooking chamber, such as the formation of regions of reduced or no air flow.

It is known from the prior art to reverse the direction of rotation of a fan of the circulating device at regular intervals and thus obtain a more homogeneous temperature distribution, at least on average, throughout the entire cooking process. For example, EP 2 426 419 A1 proposes a method for carrying out a cooking process in which the time of corresponding changes in the direction of rotation of the fan is set as a function of certain design features of the cooking appliance, for example the number of fans, and as a function of parameters of the cooking process and/or parameters of the food to be cooked. However, determining cycle times for the changes in the direction of rotation of the fans, as proposed in EP 2 426 419 A1, is generally not sufficient to influence the cooking chamber atmosphere with sufficient precision to ensure an optimal cooking result.

### SUMMARY

In an embodiment, the present invention provides a method for operating a cooking appliance having a cooking chamber for receiving a food to be cooked, a heating device for heating the cooking chamber, a circulating device including at least one fan for circulating air in the cooking chamber, and a control device for controlling at least the circulating device, the method comprising: recording at least one image of the food to be cooked by an image recording device; evaluating the at least one image to determine at least one surface state of the food to be cooked; determining a spatial browning profile by comparing surface states of the food to be cooked at at least two mutually spaced positions of the food to be cooked; and controlling the circulating device as a function of the spatial browning profile.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a cooking appliance according to the invention;

FIG. 2 shows a greatly simplified view of a cooking chamber with a fan in a top view;

FIG. 3 shows the subject matter according to FIG. 2 during operation for influencing the heat distribution in an embodiment of the invention;

FIG. 4 shows the cooking chamber according to FIG. 2 during operation for influencing the heat distribution in a further embodiment of the invention.

### DETAILED DESCRIPTION

In an embodiment, the present invention provides a method for operating a cooking appliance and a corresponding cooking appliance in which improved influencing of the cooking chamber atmosphere is possible.

The method according to the invention serves to operate a cooking appliance comprising a cooking chamber for receiving a food to be cooked, a heating device for heating the cooking chamber, a circulating device comprising at least one fan for circulating air in the cooking chamber, and a control device for controlling at least the circulating device. The method is characterized in that at least one image of the food to be cooked is recorded by means of an image recording device, which image is evaluated to determine at least one surface state or, more specifically, a degree of browning of the food to be cooked. In particular, in the present case, an image is understood to mean any type of data set which is recorded by means of an optical sensor of the image recording device, records the data on spectral intensities such as, for example, color values of individual measuring points and/or measuring surfaces and, in particular, provides said data for comparison purposes. The surface state is calculated from these intensities per pixel and can represent in particular a browning state, intensities of the red, yellow and blue color values of the visible spectrum, or a surface temperature, intensities of the thermal radiation of the infrared spectrum, of the food to be cooked. Both measuring methods can serve as a measure of the uniformity of the cooking result. Differences in the surface temperature lead to browning differences due to the cooking process, such that the first is a direct measurement and the second is an indirect measurement of the browning. In particular, an RGB camera or infrared camera is suitable as image recording unit. In this case, a spatial browning profile is determined by comparing the degrees of browning of the food to be cooked at at least two mutually spaced positions of the food to be cooked. The circulating device is controlled as a function of the determined browning profile. Monitoring a degree of browning on the basis of RGB or LAB color values of an image recorded by means of an RGB camera as an image recording device is the case for implementation. However, temperature monitoring with an IR camera is the preferred solution because it allows the problem to be recognized and counteracted at an earlier stage. In fact, temperature differences on the food to be cooked only lead to browning differences after a certain time.

By monitoring the spatial profile of the browning, the distribution of heat in the cooking chamber can be deduced. In particular, the spatial profile shows the change in the browning value as a function of the local position. The circulating device is controlled as a function of the spatially resolved browning distribution of the food to be cooked in order to adjust the heat input into the food to be cooked by influencing the air flow conditions in a targeted manner. This allows the cooking chamber atmosphere to be controlled according to the cooking process in progress. In addition to a particularly uniform heat distribution, inhomogeneous heat distribution can also be aimed for in a targeted manner, so that, for example, foods with different cooking times can also be cooked simultaneously.

The method according to the invention provides an extremely reliable contactless determination of the heat distribution in the cooking chamber on the basis of optical features of the food to be cooked. Spectral intensities, such as the color values of the pixels of the recorded image, can be evaluated to detect browning or a browning profile. The color value is in particular understood to mean a coordinate of a color in a multidimensional color space (e.g., RGB, CIELAB, CIEYUV, etc.). The browning of the food to be cooked is understood in particular as the discoloration of the food to be cooked as a result of the Maillard reaction that takes place during heating.

Similar information can be obtained by evaluating the thermal radiation in the infrared spectrum and deriving the browning profile from the surface temperatures of the food to be cooked. In particular, intensities in the wavelength range of 2.5 to 25 μm are suitable for determining the surface temperature. In special cases, the measurement of small wavelength ranges, for example around 950 nm, may also be sufficient to infer a browning state of the food because a water absorption band is located around 950 MHz. By measuring this intensity, it is possible to infer the water content on the surface of the food to be cooked. Only when the water has evaporated sufficiently can surface temperatures higher than 100° C. be achieved and browning effects occur.

Because the image recorded by the image recording device provides sufficient measurement data to determine a spatial browning profile, it is possible to dispense with the use of measurement systems having a plurality of measuring probes, for example temperature sensors, for measuring the heat distribution, in particular in cooking appliances which are already equipped with an image recording device, for example in the form of a camera directed into the cooking chamber, the method according to the invention can be implemented or retrofitted in a cost-effective manner, for example by a simple software update. The cooking appliance and/or the image recording device preferably has an evaluation device with which the recorded image of the food is evaluated to determine a spatial browning profile. The recording of the image and the determination of the spatial browning profile can be repeated periodically or at irregular intervals. The browning of the food to be cooked is preferably monitored over the entire cooking process. For comparison purposes, (image) data records or intermediate values calculated therefrom can be temporarily stored.

The relationship between the detected browning profile of the food to be cooked and a setting of the circulating device optimized for the desired cooking result can be determined empirically, for example, as a function of the type and/or the composition of the food to be cooked, and stored in the cooking appliance, in particular at the factory. Preferably, a type and/or a composition of the food to be cooked is determined and taken into account in the method. For example, this information can be entered by users of the cooking appliance. Alternatively or additionally, the food to be cooked can be automatically recognized and characterized in particular by means of a recorded image.

According to this invention, stoves, ovens, oven-combination devices with a steam cooking and/or microwave function and ovens with high-frequency technology are particularly suitable as cooking appliances.

The heating device preferably comprises at least one bottom heater, one top heater, one grill heater and/or one annular heating element arranged around the at least one fan as a thermal heating source. Preferably, the cooking appliance further comprises a steam generator.

The control of the circulating device may include the following: switching the circulating device on or off, adjusting a conveying speed of at least one fan of the circulating device (for example by adjusting the speed and/or adjusting an angle of attack of the rotor blades of the fan), adjusting a conveying direction of at least one fan of the circulating device (for example by adjusting the direction of rotation of the fan and/or adjusting the guide vanes arranged in the air flow of the fan).

In a preferred embodiment of the invention, in the event that the food to be cooked has a plurality of separate food components, the browning profile for each individual food component is determined and taken into account in the control of the circulating device. In this way, the heat distribution in the cooking chamber acting on the respective food components can be detected even more precisely and used for optimal control of the circulating device. For example, separate food components can be detected by means of an algorithm for image recognition and classified as an independent image segment in which a spatial browning profile is determined by comparing the degrees of browning of the food component at at least two mutually spaced positions of the food component.

In a further advantageous embodiment of the invention, the heating device is controlled as a function of the determined browning profile. In this way, the heat distribution can be influenced not only by influencing the air flow, but also by influencing the heat output delivered to the cooking chamber. The heating device preferably has at least one heating source having individually controllable segments which can heat different regions of the cooking chamber. Preferably, the heating device comprises a heating element arrangement arranged around the fan with at least two heating elements which are separately controlled as a function of the determined browning profile. This allows a direction-dependent heating, in particular of the air flow, as a result of which the heat distribution in the cooking chamber can be controlled even better and more precisely. If, for example, a certain browning profile indicates an advantageous heat distribution in a region of the cooking chamber, the air flow penetrating into this region can be influenced in a targeted manner by regulating a corresponding heating element. The heating element arrangement arranged around the fan can be designed, for example, as an annular heating element having individually controllable segments.

In a further preferred embodiment of the invention, a conveying speed of the fan is adapted if the determined browning profile along a first direction perpendicular to a wall of the cooking chamber, in particular to a rear wall of the cooking chamber, arranged at and/or behind the fan, deviates from a desired browning profile or a target browning profile in this direction. In this way, a heat distribution along this first direction, which, in conventional household appliances in which the circulating device is arranged on the rear wall of the cooking chamber, corresponds to the insertion direction for the food carriers, can be adjusted particularly precisely. For example, if the determined browning profile indicates that there is too little heat in a region farther away from the fan than in a closer region, the air flow can be adapted by increasing the conveying speed in such a way that the flow increases in the far-away region and consequently more heat can be emitted there. The conveying speed is preferably regulated by adjusting the rotational speed and/or by adjusting an angle of attack of the rotor blades of the fan.

In a further preferred embodiment of the invention, a conveying direction of the fan is adapted if the determined browning profile along a second direction parallel to the wall of the cooking chamber, in particular to the rear wall of the cooking chamber, arranged at and/or behind the fan, deviates from a desired browning profile or target browning profile in this second direction. In this way, a heat distribution along this second direction, which extends in particular vertically or horizontally, can be adjusted particularly precisely. For example, the conveying direction can be adjusted in such a way that the air flow increases in a region of the cooking chamber in which there was too little heat, resulting in more heat being emitted there. Preferably, the conveying direction of the fan is controlled by adjusting the direction of rotation of the fan and/or by adjusting the guide vanes arranged in the air flow of the fan.

In a further preferred embodiment of the invention, the cooking chamber is divided into at least two non-overlapping, in particular substantially same-sized, monitoring zones, the browning profile being determined on the basis of a comparison of the degrees of browning of the monitoring zones. In particular, the monitoring zones each comprise a plurality of image pixels. In this way, the image evaluation and the control of the circulating device based thereon can be simplified considerably. Preferably, the monitoring zones are divided in such a way that at least two of the monitoring zones are arranged next to one another in the first direction perpendicular to the wall of the cooking chamber, arranged at and/or behind the fan, and/or in the second direction parallel to the wall of the cooking chamber, arranged at and/or behind the fan. For example, the cooking chamber can be divided into four quadrants serving as monitoring zones from a perspective from above and/or from the perspective of the image recording device. Preferably, a degree of browning of each monitoring zone is determined by calculating a tendency value, in particular a mean value, from the color values of the image, so that only one scalar value per monitoring zone needs to be evaluated for calculating the browning profile.

In a further preferred embodiment of the invention, the size of at least one opening of an air guide plate of the cooking appliance arranged upstream of the fan is changed as a function of the determined browning profile by means of an adjusting element which can be controlled by the control device. In this way, a particularly precise change in the air flow conditions is possible, allowing the heat distribution in the cooking chamber to be effectively regulated. The opening of the air guide plate can be openings within the air guide plate or one or more openings defined by the air guide plate and a wall of the cooking chamber.

In a further preferred embodiment of the invention, the circulating device has a plurality of fans which are actuated together, individually or in groups as a function of the degree of browning determined.

The circulating device preferably has a plurality of fans which are actuated individually, together or in groups as a function of the degree of browning determined.

The cooking appliance according to the invention has a cooking chamber for receiving a food to be cooked, a heating device for heating the cooking chamber, a circulating device comprising at least one fan for circulating air in the cooking chamber, and a control device for controlling at least the circulating device. The cooking appliance according to the invention is characterized in that it has an image recording device and is suitable and designed for this purpose, in particular is configured via the control device to carry out the method described herein.

The cooking appliance according to the invention has same advantages as the method according to the invention.

It is expressly noted that any of the embodiments of the invention explained above can each be combined with the subject matter of any of the independent claims by itself or in any technically meaningful combination.

Parts that are the same or similar are given identical reference signs where applicable.

Individual technical features of the embodiments described below can also be combined in combination with previously described embodiments and the features of the independent claims and any further claims for subject matters according to the invention.

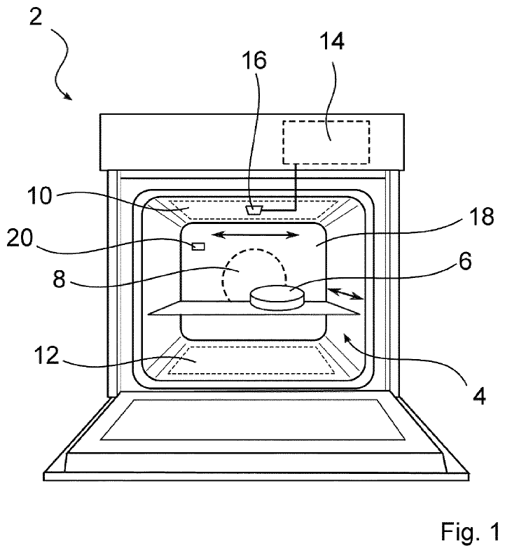

FIG. 1 shows a cooking appliance 2 according to the invention having a cooking chamber 4 for receiving a food to be cooked 6, a heating device for heating the cooking chamber 4, a circulating device comprising at least one fan 8 for circulating air in the cooking chamber 4. In the present embodiment, the heating device comprises a top heating heater unit 12, a bottom heating heater unit 10 below the cooking chamber floor, and an annular heater arranged around the fan 8. A control device 14 is used, among other things, to control the heating device and the circulating device. The cooking appliance 2 is further equipped with an image recording device 16 in the form of a camera which is arranged outside an insulation of the cooking chamber 4 and can take images of the food to be cooked 6 through a transparent window. In this embodiment, the control device 14 is also used as an evaluation device which is configured to evaluate the image recorded of the food to be cooked 6 for determining at least one degree of browning of the food to be cooked 6, to determine a spatial browning profile by comparing the degrees of browning of the food to be cooked 6 at at least two mutually spaced positions of the food to be cooked 6, and to control at least the circulating device as a function of the determined browning profile.

The fan 8 is arranged downstream of an air guide plate 18 arranged substantially parallel to a rear wall of the cooking chamber 4. Said fan has at least one opening 20, the size of which can be changed as a function of the determined browning profile by means of an adjusting element that can be controlled by the control device 14 in order to influence the air flow conditions in the cooking chamber 4. For example, the opening 20 can be closed in this way.

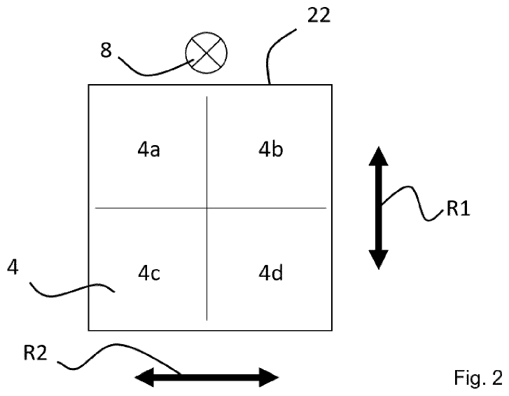

FIGS. 2 to 4 schematically and in a greatly simplified manner show a cooking chamber 4 in plan view, which is divided into four monitoring zones 4a, 4b, 4c, 4d or quadrants, air located in the cooking chamber 4 being circulated by means of a fan 8 of a circulating device. The fan 8, which is generally arranged at and/or behind a rear wall 22 of the cooking chamber 4, is only shown outside the cooking chamber 4 for the sake of improved clarity. In the embodiments of FIGS. 2 to 4, the axis of rotation of the fan 8 is oriented parallel to a first direction R1 and is shown perpendicular to the plane of the figure only for better illustration. The monitoring zones 4a, 4b, 4c, 4d are divided in such a way that two monitoring zones 4a, 4b; 4c, 4d are arranged next to one another in the first direction R1 extending perpendicular to the rear wall 22 and two monitoring zones 4a, 4c; 4b, 4d are arranged next to one another in a second direction R2 extending parallel to the rear wall 22.

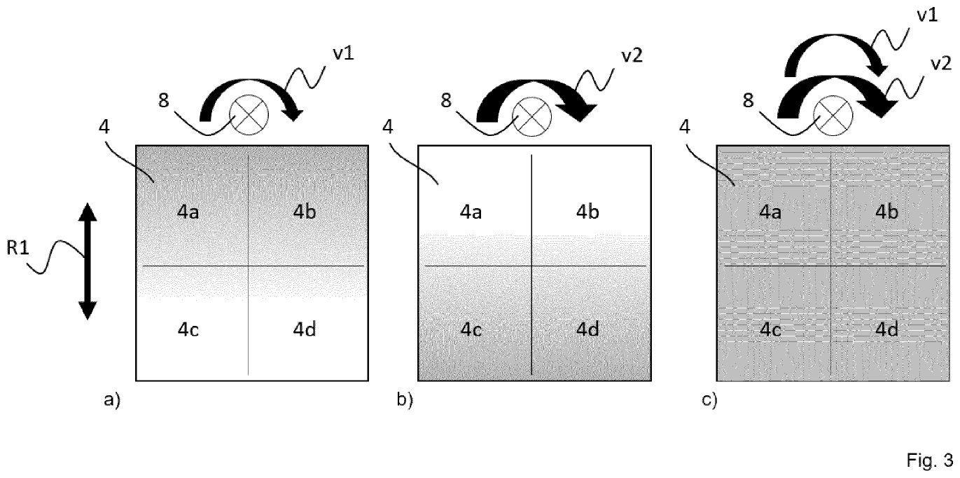

FIG. 3 illustrates the influence of operating the fan 8 in the first direction R1 on the heat distribution (shown as a gray color profile). In this case, the first direction R1 corresponds in particular to an insertion direction for food carriers. FIG. 3a) shows the operation of the fan 8 at a first conveying speed v1, in this case more heat being present in the monitoring regions 4a, 4b arranged closer to the fan 8 than in the monitoring regions 4c, 4d arranged far away. By adjusting a higher second conveying speed v2 of the fan, for example by increasing the speed of the fan 8, the air flow conditions are changed such that more heat is present in the monitoring regions 4c, 4d arranged far away than in the monitoring regions 4a, 4b arranged closer to the fan 8 (see FIG. 3b)). A homogeneous heat distribution can be achieved as a result by operating the fan 8 during a cooking process, sometimes at the first conveying speed v1 and sometimes at the second conveying speed v2 (see FIG. 3c)).

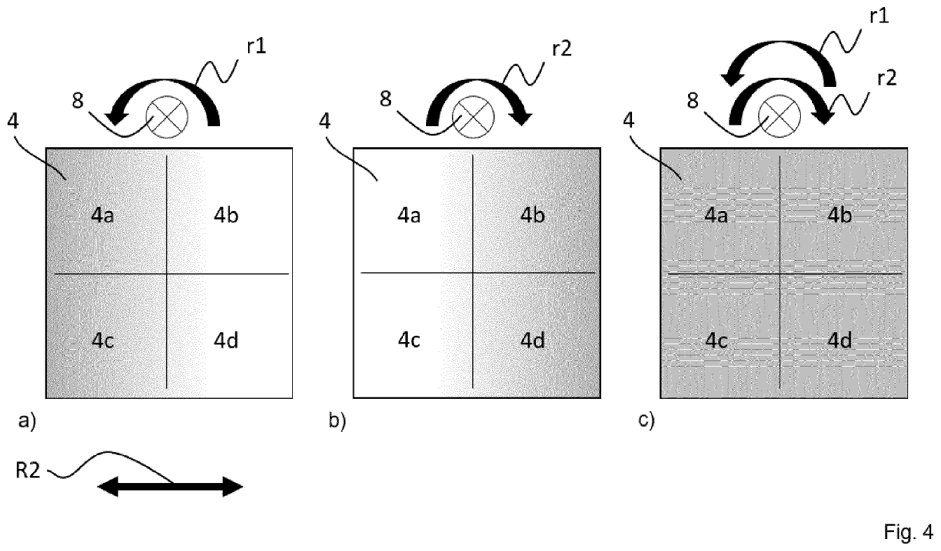

FIG. 4 illustrates the influence of operating the fan 8 in the second direction R2 on the heat distribution (shown as a gray color profile). In this case, the second direction R2 corresponds in particular to a horizontal direction. FIG. 4a) shows the operation of the fan 8 with a first conveying direction r1, in this case more heat being present in the monitoring regions 4a, 4c arranged to the left of the fan 8 than in the monitoring regions 4b, 4d arranged to the right of the fan 8. FIG. 4b) shows that by adjusting an inverted second conveying direction r2 of the fan, for example by reversing the direction of rotation of the fan 8, the air flow conditions are changed such that more heat is present in the monitoring regions 4b, 4d arranged to the right of the fan 8 than in the monitoring regions 4a, 4c arranged to the left of the fan 8. As shown in FIG. 4c), a homogeneous heat distribution can be achieved as a result by operating the fan 8 during a cooking process, sometimes with the first conveying direction r1 and sometimes with the second conveying direction r2.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for operating a cooking appliance having a cooking chamber for receiving a food to be cooked, a heating device for heating the cooking chamber, a circulating device including at least one fan for circulating air in the cooking chamber, and a control device for controlling at least the circulating device, the method comprising:
recording at least one image of the food to be cooked is by an image recording device;
evaluating the at least one image to determine at least one surface state of the food to be cooked;
determining a spatial browning profile by comparing surface states of the food to be cooked at at least two mutually spaced positions of the food to be cooked; and
controlling the circulating device as a function of the spatial browning profile.

2. The method of claim 1, wherein a degree of browning is determined as the surface state based on RGB or LAB color values of an image recorded by an RGB camera as an image recording device.

3. The method of claim 1, wherein the at least one surface state is determined based on surface temperatures measured by an infrared camera as an image recording device.

4. The method of claim 1, wherein, if the food to be cooked has a plurality of separate food components, the browning profile for each individual food component of the plurality of separate food components is determined and taken into account to control the circulating device.

5. The method of claim 1, wherein the heating device is controlled as a function of the spatial browning profile.

6. The method of claim 5, wherein the heating device comprises a heating element arrangement arranged around the at least one fan with at least two heating elements which are separately controlled as a function of the spatial browning profile.

7. The method of claim 1, wherein a conveying speed of the at least one fan is adapted based on the spatial browning profile along a first direction perpendicular to a rear wall of the cooking chamber, arranged at and/or behind the at least one fan, deviating from a desired (target) browning profile in the first direction.

8. The method of claim 7, wherein a conveying direction of the at least one fan is adapted based on the spatial browning profile along a second direction parallel to the rear wall of the cooking chamber, arranged at and/or behind the at least one fan, deviating from a desired (target) browning profile in the second direction.

9. The method of claim 1, wherein the cooking chamber is divided into at least two non-overlapping substantially equal monitoring zones, the browning profile being determined based on a comparison of degrees of browning of the monitoring zones.

10. The method of claim 9, wherein the monitoring zones are divided such that at least two of the monitoring zones are arranged next to one another in a first direction perpendicular to a wall of the cooking chamber, arranged at and/or behind the at least one fan, and/or in a second direction parallel to the wall of the cooking chamber, arranged at and/or behind the at least one fan.

11. The method of claim 1, wherein a size of at least one opening of an air guide plate of the cooking appliance arranged upstream of the at least one fan is changed as a function of the spatial browning profile by an adjusting element which is actuatable by the control device by closing the at least one opening.

12. The method of claim 1, wherein the circulating device has a plurality of fans which are actuated together, individually, or in groups as a function of a determined degree of browning.

13. A cooking appliance, comprising:
a cooking chamber configured to receive a food to be cooked;
a heating device configured to heat the cooking chamber;
a circulating device comprising at least one fan configured to circulate air in the cooking chamber; and
a control device configured to control at least the circulating device,
wherein the cooking appliance has an image recording device and is configured to carry out the method of claim 1.
